(19) United States
(12) Patent Application Publication
(10) Pub. No.: US 2006/0151652 A1
(43) Pub. Date: Jul. 13, 2006

(54) Tape reel assembly having an end plate defining a polygonal drive bore

(75) Inventor: Christopher J. Zwettler, Lake Elmo, MN (US)

Correspondence Address: Attention: Eric D. Levinson;Imation Corp, Legal Affairs, P.O. Box 64898, St. Paul, MN, 55164-0898, US

(73) Assignee: Imation Corp.

(21) Appl. No.: 11/018,606

(22) Filed: Dec. 21, 2004

(51) Int. Cl. G11B 23/107

(52) U.S. Cl. 242/348

(57) ABSTRACT

A tape reel assembly for a data storage tape cartridge is described. The tape reel assembly includes a ring defining a tape winding surface, and a separate end plate coupled to the ring. In this regard, the end plate defines a polygonal drive bore.

### THE FIELD OF THE INVENTION

The present invention relates to a tape reel assembly for a data storage tape cartridge. More particularly, it relates to a self-centering tape reel assembly having an endplate defining a polygonal drive bore.

### BACKGROUND OF THE INVENTION

Data storage tape cartridges have been used for decades in the computer, audio, and video fields. The data storage tape cartridge continues to be a popular device for recording large volumes of information for subsequent retrieval and use.

A data storage tape cartridge generally consists of an outer shell or housing maintaining at least one tape reel assembly and a length of magnetic storage tape. The storage tape is wrapped about a hub of the tape reel assembly and is driven through a defined path by a tape drive. The housing normally includes a separate cover and a separate base. Together, the cover and the base form an opening (or window) at a forward portion of the cartridge permitting access to the storage tape by a read/write head after the data storage tape cartridge is inserted into the tape drive. The interaction between the storage tape and the read/write head occurs within the cartridge housing for a mid-tape load design. Conversely, the interaction between the storage tape and the read/write head is exterior to the cartridge housing for a helical drive design. Where the tape cartridge/tape drive is designed to direct the storage tape away from the housing, the data storage tape cartridge normally includes a single tape reel assembly employing a leader block design. Alternately, where the tape cartridge/tape drive interaction occurs within the housing, a dual tape reel configuration is typically employed.

Regardless of the number of the tape reel assemblies associated with a particular data storage tape cartridge, the tape reel assembly generally includes three elements: an upper flange, a lower flange, and a hub. The flanges are optional, and, when employed, are disposed at opposite ends of the hub and spaced apart to accommodate a width of the storage tape. The hub includes a core that forms an inner surface opposite a tape winding surface. The storage tape is wound about the tape winding surface. To reduce the likelihood of the storage tape undesirably contacting one of the flanges during a winding operation, the flange-to-flange spacing is selected to be slightly greater than the width of the tape.

Reading information from, or writing information to, the storage tape requires the tape reel assembly to be rotated such that a desired portion of the storage tape can be located and accessed by the read/write head. During a read/write operation, the data storage tape cartridge is inserted into the tape drive such that an engagement chuck of the tape drive engages the tape reel assembly. A coupling of the tape reel assembly by the tape drive is known as “chuck-up.” To this end, the tape reel assembly is provided with drive teeth that are configured to couple with teeth formed on the engagement chuck. During chuck-up, the teeth on the engagement chuck engage with the drive teeth of the tape reel assembly, thus orienting the tape reel assembly relative to the tape drive. Thereafter, tape drive transfers torque through the drive teeth to rotate the tape reel assembly to wind/unwind the data storage tape.

With the above description in mind, the chuck-up step determines the axial position of the tape reel assembly relative to the tape drive. As a point of reference, in an exemplary available cartridge/drive system approximately 60 drive teeth are provided on a drive portion of the tape reel assembly, and 60 opposing and complimentary teeth provided on the engagement chuck are intended to mesh with the drive teeth. In this regard, during each chuck-up, a variation in the radial centering of the tape reel assembly with respect to the tape drive can occur whenever the drive teeth fail to mesh precisely with the engagement chuck teeth.

In addition, when the drive teeth fail to mesh properly with the engagement chuck teeth, the tape reel assembly will tilt relative to the tape drive and this axial misalignment can effect rotation of the tape reel assembly. Moreover, after prolonged use, the drive teeth of the tape reel assembly can become worn by exposure to the hardened teeth of the engagement chuck, thus creating debris and further affecting the axial and radial alignment of the tape reel assembly relative to the tape drive.

Data storage tape cartridges are useful tools for collecting and protecting information stored on data storage tape. However, the drive teeth of the tape reel assembly are vulnerable to wear and misalignment with the tape drive. Therefore, a need exists for a self-centering tape reel assembly that can be repeatably and reproducibly aligned relative to a tape drive during chuck-up.

### SUMMARY OF THE INVENTION

One aspect of the present invention relates to a tape reel assembly for a data storage tape cartridge. The tape reel assembly includes a ring defining a tape winding surface, and a separate end plate coupled to the ring. In this regard, the end plate defines a polygonal drive bore.

Another aspect of the present invention relates to a data storage tape drive system. The data storage tape drive system includes a data storage tape cartridge and a tape drive including a toothless engagement chuck. The data storage tape cartridge includes a tape reel assembly rotatably disposed within a housing of the cartridge, and a storage tape wound about the tape reel assembly. The tape reel assembly includes a ring defining a tape winding surface, and a separate end plate coupled to the ring. In this regard, when the toothless engagement chuck couples with the end plate, the tape reel assembly is axially aligned and radially centered relative to the tape drive.

Yet another aspect to the present invention relates to a method of accessing storage media in a data storage tape cartridge. The method includes inserting a data storage tape cartridge into a tape drive. In this regard, the data storage tape cartridge houses a tape reel assembly having a ring defining a tape winding surface, and a separate end plate coupled to the ring, the end plate defining a non-circular drive bore. The method additionally includes engaging a drive shaft of the tape drive with the non-circular drive bore of the end plate. The method further includes toothlessly rotating the tape reel assembly for access to a data storage tape wound about the tape winding surface.

### BRIEF DESCRIPTION OF THE DRAWINGS

Embodiments of the invention are better understood with reference to the following drawings. The elements of the drawings are not necessarily to scale relative to each other. Like reference numerals designate corresponding similar parts.

FIG. 1 is an exploded, perspective view of a data storage tape cartridge according to one embodiment of the present invention;

FIG. 2 is an exploded, perspective view of a tape reel assembly including a core having an end plate defining a polygonal drive bore according to one embodiment of the present invention.

FIG. 3 is a cross-sectional view of the tape reel assembly core shown in FIG. 2;

FIG. 4 is a cross-sectional view of a tape reel assembly core according to another embodiment of the present invention;

FIG. 5 is a cross-sectional view of a data storage tape drive system including the cartridge of FIG. 1 and a tape drive according to one embodiment of the present invention; and

FIG. 6 is a top view of a toothless engagement chuck including a polygonal drive shaft according to one embodiment of the present invention.

### DETAILED DESCRIPTION OF THE PREFERRED EMBODIMENTS

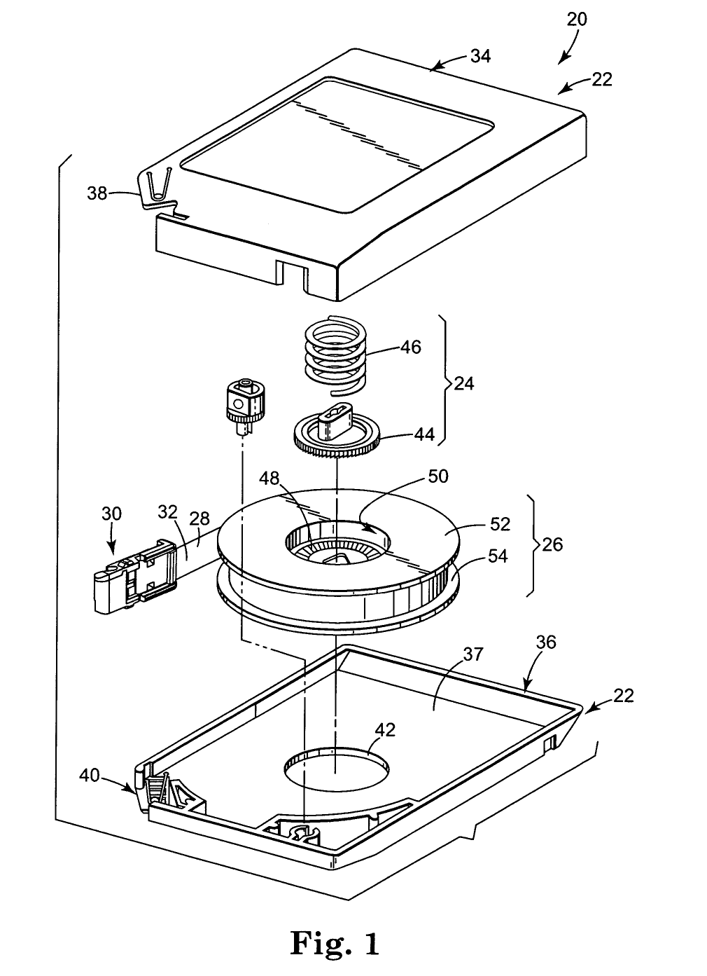

An exemplary single reel data storage tape cartridge according to one embodiment of the present invention is illustrated at 20 in FIG. 1. Generally, the data storage tape cartridge 20 includes a housing 22, a brake assembly 24, a tape reel assembly 26, a storage tape 28, and a leader block 30. The tape reel assembly 26 is disposed within the housing 22. The storage tape 28, in turn, is wound about the tape reel assembly 26 and includes a leading end 32 attached to the leader block 30. As a point of reference, while a single reel data storage tape cartridge 20 is shown, the present invention is equally applicable to other cartridge configurations, such as dual reel cartridges.

The housing 22 is sized for insertion into a typical tape drive (not shown). Thus, the housing 22 exhibits a size of approximately 125 mm×110 mm×25 mm, although other dimensions are equally acceptable. With this in mind, the housing 22 is defined by a first housing section 34 and a second housing section 36. In one embodiment, the first housing section 34 forms a cover and the second housing section 36 forms a base. As used throughout the specification, directional terminology such as “cover,” “base,” “upper,” “lower,” “top,” “bottom,” etc., is employed for purposes of illustration only and is in no way limiting.

The first and second housing sections 34 and 36, respectively, are each sized to be reciprocally mated to one another to form an enclosed region 37 and are generally rectangular, except for one corner 38 that is preferably angled and forms a tape access window 40. The leader block 30 covers the tape access window 40 during storage. When not covered by the leader block 30, the tape access window 40 serves as an opening for the storage tape 28 to exit from the housing 22 when the leader block 30 and tape 28 is threaded to a tape drive system (not shown).

In addition to forming a portion of the tape access window 40, the second housing section 36 also forms a central opening 42. The central opening 42 facilitates access to the tape reel assembly 26 by an engagement chuck of the tape drive (neither shown). During use, the engagement chuck enters the central opening 42 to disengage the brake assembly 24 prior to rotating the tape reel assembly 26 for access to the storage tape 28. The brake assembly 24 is of a type known in the art and generally includes a brake body 44 and a spring 46 co-axially disposed within the tape reel assembly 26. When the data storage tape cartridge 20 is idle, the brake assembly 24 is engaged with a brake interface 48 to selectively “lock” the single tape reel assembly 26 to the housing 22.

The storage tape 28 is preferably a magnetic data storage tape of a type known in the art. For example, the storage tape 28 can be a balanced polyethylene naphthalate (PEN)-based material having one or more magnetic coatings. For example, in one embodiment, the (PEN)-based material is coated on one side with a layer of magnetic material dispersed within a suitable binder system, and coated on an opposing side with a conductive material dispersed within a suitable binder system. Acceptable magnetic data storage tape is available, for example, from Imation Corp., of Oakdale, Minn.

The leader block 30 covers the tape access window 40 during storage of the cartridge 20 and facilitates retrieval of the storage tape 28 for read/write operations. In general terms, the leader block 30 is shaped to conform to the window 40 of the housing 22 and to cooperate with the tape drive (not shown) by providing a grasping surface for the tape drive to manipulate in threading the storage tape 28 across the read/write head. In this regard, the leader block 30 can be replaced by other components, such as a dumb-bell shaped pin. Moreover, the leader block 30, or a similar component, can be eliminated entirely, as is the case with dual reel cartridge designs.

The tape reel assembly 26 includes a core 50, an upper flange 52, and a lower flange 54. The upper and lower flanges 52, 54 are optional, and when employed extend in a radial fashion from opposing sides of the core 50, respectively.

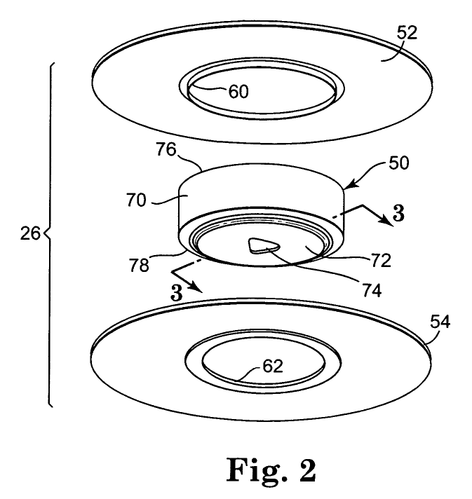

FIG. 2 is a perspective, exploded view of the tape reel assembly 26 shown in FIG. 1. In one embodiment, the tape reel assembly 26 is a three-piece assembly including the core 50, and the upper and lower flanges 52, 54. In one exemplary embodiment, the upper flange 52 includes an annular arm 60 configured to engage over a top portion of the core 50, and the lower flange 54 includes an annular arm 62 configured to engage over a lower portion of the core 50. Alternately, the flanges 52, 54 can be eliminated such that the tape reel assembly 26 is a flange-less tape reel assembly defined by the core 50.

With regard to the core 50, in one embodiment the core 50 includes a ring 70, and a separate end plate 72 coupled to the ring 70 and defining a polygonal drive bore 74. In this regard, the ring 70 includes a first side 76 opposite a second side 78. In an exemplary embodiment, the end plate 72 is coupled to the second side 78 of the ring 70. With this in mind, the end plate 72 can be coupled to the ring 70 by any means suited to rigidly attach the end plate 72 to the ring 70 and permit a transfer of torque from a tape drive (not shown) to the end plate 72 in rotating the core 50 (and therefore the tape reel assembly 26). For example, in one embodiment the end plate 72 is spin welded to the ring 70. In another embodiment, the end plate 72 is ultrasonically tack welded to the ring 70. In one preferred embodiment, end plate 72 is integrally formed with an insert portion that is inset into the ring 70, as described in detail below.

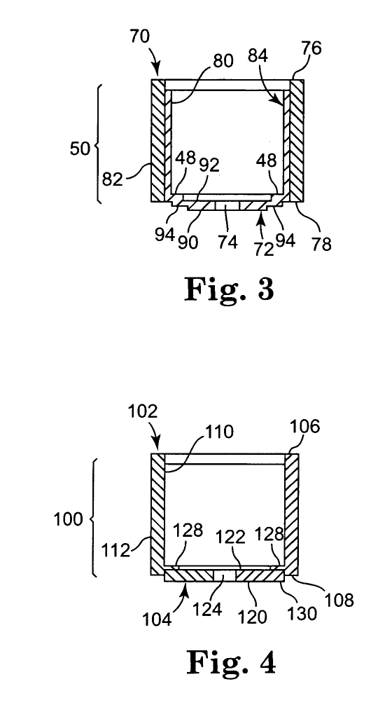

FIG. 3 is a cross-sectional view of the core 50 through section 3-3 as shown in FIG. 2. Generally, in the following embodiments the ring 70 includes an inner surface 80 opposite a tape winding surface 82. However, in a preferred embodiment, a cup shaped member 84 is provided that integrally defines the inner surface 80 and the end plate 72. In this regard, the ring 70 and the cup shaped member 84 combine to define the core 50, and an annular portion of the cup shaped member 84 is over-molded with, for example, a plastic tape winding surface 82. With this in mind, the cup shaped member 84 can be formed of any material that is suitable for integrally forming the inner surface 80 and the end plate 72. In one exemplary embodiment, the cup shaped member 84 is formed of a magnetic metal that is suitably stiff to prevent deformation of the core 50 when the storage tape 28 is wrapped about the core 50, and responsive to magnetic attraction of a tape drive, as described more fully below.

The end plate 72 includes a drive side 90 opposite a brake side 92. In one embodiment, the brake side 92 includes the brake interface 48, as best illustrated in FIG. 1. The drive side 90 of the end plate 72 is toothless, and in one embodiment includes a smooth periphery 94. The periphery 94 of the end plate 72 is preferably formed to be highly smooth, such that at least a portion of the periphery 94 can serve as a datum pad to axially align the core 50 relative to a tape drive (not shown). In a preferred embodiment, the periphery 94 of the end plate 72 is a continuous ring having a highly smooth surface characterized by an axial run-out of less than 0.005 inch, more preferably the axial run-out is less than 0.001 inch. In this regard, it is desirable that the periphery 94 has a surface roughness of, for example, approximately 8 micro-inches.

With additional reference to FIG. 2, the polygonal drive bore 74 is preferably a tri-lobe polygonal drive bore 74, although other shapes and configurations of the polygonal drive bore 74 are equally acceptable. For example, in one embodiment, end plate 72 defines a square polygonal drive bore. In an alternate embodiment, the end plate 72 defines a pentagonal polygonal drive bore. In any regard, the polygonal drive bore 74 is non-circular and includes a plurality of sides that center the tape reel assembly 26 relative to a tape drive (not shown) during chuck-up, and enable an efficient and toothless transfer or torque from a tape drive (not shown) to the tape reel assembly 26 during read/write operations.

FIG. 4 is a cross-sectional view of an alternate core 100 according to one embodiment of the present invention. The core 100 includes a ring 102 and a separate end plate 104 coupled to the ring 102. In this regard, the ring 102 includes a first side 106 opposite a second side 108, and in one embodiment, the end plate 104 is coupled to the second side 108 of the ring 102.

In a preferred embodiment, the ring 102 is a unitary annulus formed of a homogenous material that defines an inner surface 110 opposite a tape winding surface 112. The ring 102 is preferably sufficiently stiff to resist a radial deformation when the storage tape 28 (FIG. 1) is wound onto the tape winding surface 112. In one exemplary embodiment, the ring 102 is formed of a polycarbonate material. In a preferred embodiment, the ring 102 is formed of a glass-filled polycarbonate material including, for example, 20% glass fiber-filled polycarbonate having a modulus of approximately 0.8 million pounds per square inch. In this regard, the ring 102 is dimensionally stable and resists radial deformation as the storage tape 28 is wound onto, and off of, the tape winding surface 112.

The end plate 104 is, in one embodiment, coupled to the second side 108 of the ring 102. In an exemplary embodiment, the end plate 104 is inset into the ring 102 via a spin welding process. In an alternate embodiment, the end plate 104 is inset into one of the sides 106, 108 and tack welded to the ring 102. To this end, it is preferred that the end plate 104 be rigidly coupled to the ring 102 so as to toothlessly transmit torque delivered from a tape drive (not shown) in rotating the core 100. With this in mind, in one preferred embodiment, the end plate 104 is, for example, a metal washer inset into the second side 108 of the ring 102.

The end plate 104 includes a drive side 120 opposite a brake side 122. A polygonal drive bore 124 is formed in the end plate 104 and extends between the drive side 120 and the brake side 122. The polygonal drive bore 124 is formed and functions in substantially the same manner as the polygonal drive bore 74 (FIG. 2) described above. That is to say, the polygonal drive bore 124 radially centers the core 100 relative to a tape drive (not shown) during chuck-up, and permits a toothless transfer of torque from the tape drive to the core 100.

A brake interface 128 is formed opposite the drive side 120 of the end plate 104. In this regard, the brake interface 128 can be formed as an extension of the inner surface 110 such that the brake side 122 of the end plate 104 abuts the brake interface 128. Alternately, the brake interface 128 can be formed on the brake side 122 of the end plate 104. In any regard, the drive side 120 is uniformly smooth and is characterized by an absence of drive teeth. In this regard, at least a periphery 130 of the drive side 120 of the end plate 104 is formed to be smooth and thus configured to axially align the core 100 with an engagement chuck of a tape drive (neither shown). For example, in an exemplary embodiment, the periphery 130 of the end plate 104 is a continuous ring having a highly smooth surface characterized by an axial run-out of less than 0.005 inch, more preferably the axial run-out is less than 0.001 inch. In this regard, it is desirable that the periphery 130 has a surface roughness of, for example, approximately 8 micro-inches.

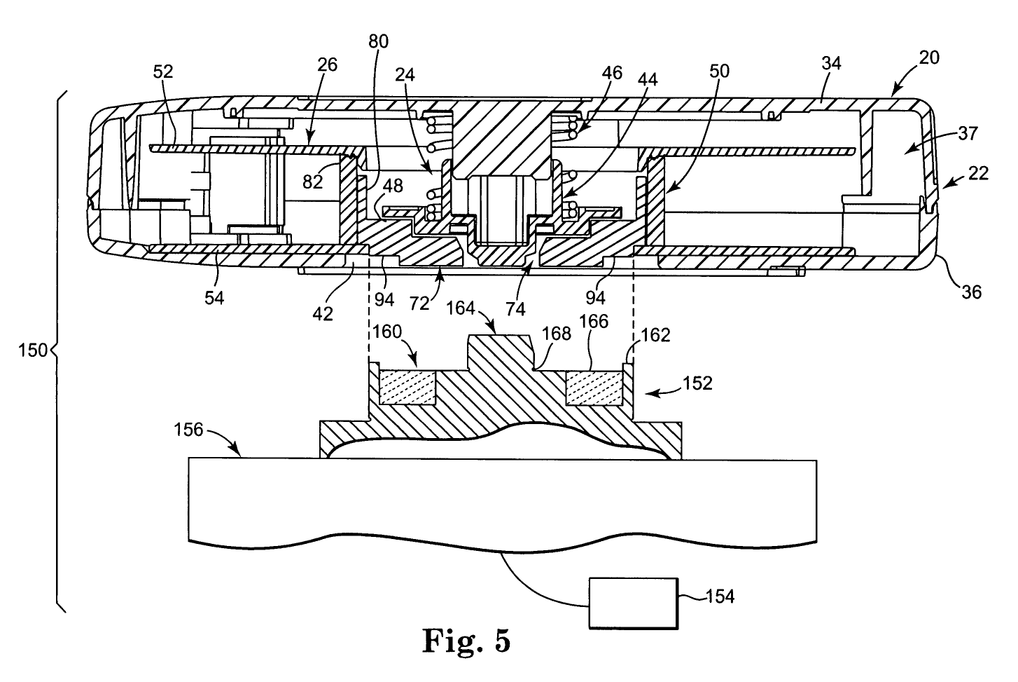

The data storage tape cartridge 20 including the tape reel assembly 26 is shown in a final, assembled form in FIG. 5. For ease of illustration, the storage tape 28 (FIG. 1) has been omitted from the cross-sectional view of FIG. 5. As previously described, the brake assembly 24 and the tape reel assembly 26 are disposed within the enclosed region 37 defined by the housing 22 such that the polygonal drive bore 74 of the end plate 72 is axially aligned with the opening 42 in the second housing section 36. Further, the brake body 44 and the spring 46 are co-axially disposed within the core 50 such that the spring 46 urges the brake body 44 to engage with the brake interface 48 and lock the tape reel assembly 26 relative to the housing 22. In the illustrated locked position, the brake body 44 and the spring 46 combine to effectively immobilize the tape reel assembly 26 within the housing 22, thereby impeding undesired rotation of the tape reel assembly 26 relative to the housing 22.

With the above in mind, the data storage tape cartridge 20 is shown in FIG. 5 as a component of a tape drive system 150. The tape drive system 150 includes the data storage tape cartridge 20 and a tape drive 152. The tape drive 152 includes a motor 154 (shown schematically) and an engagement chuck 156. The engagement chuck 156 includes an alignment surface 160, an annular datum ring 162, and a polygonal drive shaft 164 extending from the alignment surface 160. In one embodiment, the alignment surface 160 includes a recessed magnet 166 configured to magnetically attract the end plate 72 prior to eventual contact by the annular datum ring 162 with the end plate 72. A relief notch 168 is formed at a base of the polygonal drive shaft 164 adjacent to the alignment surface 160 to ensure that the polygonal drive shaft 164 seats fully into the drive bore 74. Specifically, material in a region of the drive shaft 164/alignment surface 160 interfaces has been removed to permit the polygonal drive shaft 164 to fully engage within the drive bore 74. In this regard, a transverse shape of the polygonal drive shaft 164 matches a shape of the drive bore 74 to enable a toothless transmission of torque from the drive shaft 164 to the tape reel assembly 26.

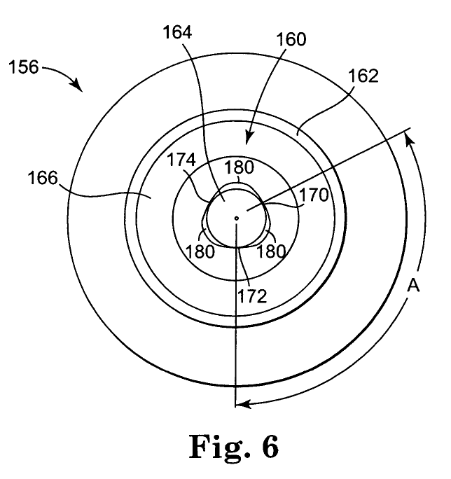

FIG. 6 is a top view of the toothless engagement chuck 156 according to one embodiment of the present invention. The alignment surface 160 includes the annular datum ring 162 and a centrally located polygonal drive shaft 164 extending from the alignment surface 160. In one embodiment, the polygonal drive shaft 164 is a tri-lobe drive shaft that includes a first side 170, a second side 172, and a third side 174, the sides 170, 172, and 174 being configured to compliment and couple with the tri-lobe drive bore 74 (FIG. 2) of the end plate 72. However, other shapes and sizes of the drive shaft 164 are equally acceptable, so long as a shape of the drive shaft 164 matches a shape of the drive bore 74. To encourage accurate and reproducible coupling of the drive shaft 164 with the drive bore 174, beveled edges 180 are provided on the drive shaft 164. In this regard, the beveled edges 180 define a chamfer along the sides 170, 172, and 174 that enable the polygonal drive shaft 164 to smoothly (i.e., without catching or binding) engage with the polygonal drive bore 74.

During use, and with reference to FIGS. 5 and 6, reading or writing information to the storage tape 28 (FIG. 1) is accomplished by the tape drive system 150 toothlessly rotating the tape reel assembly 26 to wind/unwind the storage tape 28. The data storage tape cartridge 20 is inserted into the tape drive 152 and engagement chuck 156 chucks-up with the tape reel assembly 26. As a point of reference, during chuck-up the polygonal drive shaft 164 inserts into the polygonal drive bore 74. A slight rotation of the polygonal drive shaft 164 is typically sufficient to ensure that the polygonal drive shaft 164 mates with the polygonal drive bore 74.

The polygonal drive shaft 164, when mated into the drive bore 74, disengages the brake assembly 24 simultaneously as the engagement chuck 156 engages with the tape reel assembly 26. More particularly, the polygonal drive shaft 164 displaces the brake body 44 out of the locked position and biases the spring 46 until the brake body 44 disengages with the brake interface 48 of the tape reel assembly 26. In this position, the tape reel assembly 26 is “unlocked” and free to rotate.

The engagement chuck 156 continues upward (upward relative to the orientation of FIG. 5) until the magnet 166 attracts the end plate 72, after which the annular datum ring 162 contacts the periphery 94 of the end plate 72. In particular, the magnet 166 attracts the end plate 72 without contacting the end plate 72, and permits the annular datum ring 162 to make contact with the periphery 94 of the end plate 72, thus axially aligning the engagement chuck 156 with the tape reel assembly 26 during chuck-up of the data storage tape cartridge 20 with the tape drive 152. As described above, the periphery 94 of the end plate 72 is formed to be a precisely smooth surface such that couplings with the precisely smooth annular datum ring 162 results in an accurate and reproducible axial alignment of the core 50 and the tape drive 152. To this end, in one embodiment each of the periphery 94 and the annular datum ring 162 includes a continuous ring having a highly smooth surface characterized by an axial run-out of less than 0.005 inch, more preferably the axial run-out is less than 0.001 inch. In this regard, it is desirable that each of the periphery 94 and the annular datum ring 162 has a surface roughness of approximately 8 micro-inches.

Since the polygonal drive shaft 164 applies rotational torque to the polygonal drive bore 74, it is desirable that the polygonal drive shaft 164 be configured to repeatably and reproducibly mate with the polygonal drive bore 74. To this end, the relief notch 168 ensures that the polygonal drive shaft 164 seats (i.e., inserts) fully with the polygonal drive bore 74. In addition, the relief notch 168 accommodates small amounts of debris that can be collected along the alignment surface 160, thus minimizing the deleterious effects of debris near the core 50/engagement chuck 156 interface.

After chuck-up, the polygonal drive shaft 164 is mated into the polygonal drive bore 74, and the annular datum ring 162 contacts the periphery 94 of the end plate 72. In this manner, the annular datum ring 162 axially aligns the engagement chuck 156 with the tape reel assembly 26, and the polygonal drive shaft 164 radially centers the engagement chuck 156 with the tape reel assembly 26 in a reproducibly accurate fashion.

In an alternate embodiment, the end plate 72 is provided with a polygonal drive shaft that projects outward from the end plate 72 and is configured to engage with a polygonal drive bore formed in the engagement chuck 156. With regard to this alternate embodiment, the polygonal drive shaft radially centers the engagement chuck 156 with the tape reel assembly 26, and an annular datum ring of the engagement chuck 156 axially aligns the tape reel assembly 26 for wobble-free toothless rotation of the tape reel assembly 26 by the tape drive 152.

With regard to all of the embodiments above, during rotation of the tape reel assembly the centered and aligned core spins without bouncing along the tape drive axis and without wobbling orthogonal to the tape drive axis. Consequently, through the structure and the actions described above, the tape drive system includes a self-centering tape reel assembly that is toothlessly driven by an engagement chuck.

Although specific embodiments have been illustrated and described for purposes of description of the preferred embodiment, it will be appreciated by those of ordinary skill in the art that a wide variety of alternate and/or equivalent implementations calculated to achieve the same purposes could be substituted for the specific embodiments shown and described without departing from the scope of the present invention. Those with skill in the chemical, mechanical, electro-mechanical, electrical, and computer arts will readily appreciate that the present invention may be implemented in a very wide variety of embodiments. This application is intended to cover any adaptations or variations of the preferred embodiments discussed herein. Therefore, it is intended that this invention be limited only by the following claims and their equivalents.

What is claimed is:

1. A tape reel assembly for a data storage tape cartridge comprising:
a ring defining a tape winding surface; and
a separate end plate coupled to the ring, the end plate defining a polygonal drive bore.

2. The tape reel assembly of claim 1, wherein the polygonal drive bore is a tri-lobe polygonal drive bore.

3. The tape reel assembly of claim 1, wherein the end plate includes a drive side opposite a brake side, the brake side including brake teeth.

4. The tape reel assembly of claim 1, wherein the end plate includes a drive side opposite a brake side, the drive side characterized by an absence of drive teeth.

5. The tape reel assembly of claim 1, wherein the end plate includes a drive side opposite a brake side, the drive side including at least one datum pad configured to axially align the end plate with a tape drive.

6. The tape reel assembly of claim 5, wherein the at least one datum pad is a continuous peripheral ring having an axial run-out of less than 0.005 inch.

7. The tape reel assembly of claim 1, wherein the end plate is a metal washer.

8. The tape reel assembly of claim 1, wherein a cup shaped member integrally forms an inner surface of the ring and the end plate.

9. The tape reel assembly of claim 8, wherein an annular portion of the cup shaped member is over-molded with plastic to form the tape winding surface.

10. The tape reel assembly of claim 1, wherein the tape reel assembly further includes:
an upper flange and a lower flange, the upper and lower flanges extending in a radial fashion from opposing sides of the ring, respectively.

11. A data storage tape drive system comprising:
a data storage tape cartridge including:
a tape reel assembly rotatably disposed within a housing of the cartridge, the tape reel assembly including:
a ring defining a tape winding surface,
a separate end plate coupled to the ring;
a storage tape wound about the tape winding surface; and
a tape drive including a toothless engagement chuck;
wherein, when the toothless engagement chuck couples with the end plate, the tape reel assembly is axially aligned and radially centered relative to the tape drive.

12. The data storage tape drive system of claim 11, wherein the end plate defines a polygonal drive bore, and further wherein the toothless engagement chuck couples with the polygonal drive bore to radially center the tape reel assembly relative to the tape drive.

13. The data storage tape drive system of claim 1 1, wherein a drive side of the end plate includes a peripheral datum ring that axially aligns the tape reel assembly with the toothless engagement chuck.

14. The data storage tape drive system of claim 1 1, wherein a metal cup shaped member integrally forms the end plate and an inner surface of the ring opposite the tape winding surface.

15. The data storage tape drive system of claim 11, wherein the toothless engagement chuck further comprises:
an alignment surface including an annular datum ring; and
a polygonal drive shaft extending from the alignment surface;
wherein the annular datum ring contacts the end plate to axially align the toothless engagement chuck with the tape reel assembly, and the polygonal drive shaft mates with a drive bore formed in the end plate to radially center the toothless engagement chuck with the tape reel assembly.

16. The data storage tape drive system of claim 15, wherein the alignment surface includes a magnet.

17. The data storage tape drive system of claim 15, wherein the annular datum ring has an axial run-out of less than 0.005 inch.

18. A method of accessing storage media in a data storage tape cartridge comprising:
inserting a data storage tape cartridge into a tape drive, the data storage tape cartridge housing a tape reel assembly including:
a ring defining a tape winding surface,
a separate end plate coupled to the ring, the end plate defining a non-circular drive bore;
engaging a drive shaft of the tape drive with the non-circular drive bore of the end plate; and
toothlessly rotating the tape reel assembly for access to a data storage tape wound about the tape winding surface.

19. The method of claim 18, wherein a metal cup shaped member integrally forms an inner surface of the ring and the end plate.

20. The method of claim 18, wherein engaging a drive shaft of the tape drive with the non-circular drive bore of the end plate includes contacting an annular datum ring formed on the drive shaft with the end plate to axially align the tape reel assembly with the tape drive.
